(19) United States
(12) Patent Application Publication
(10) Pub. No.: US 2011/0089888 A1
(43) Pub. Date: Apr. 21, 2011

(54) Multifunctional Notebook Battery Device

(76) Inventors: Tung-Cheng Kuo, Hsinchu City (TW); Chun-Ming Chen, Hsinchu City (TW); Huei-Chia Lo, Miaoli County (TW); Te-Sun Wu, Hsinchu City (TW)

(21) Appl. No.: 12/651,484

(22) Filed: Jan. 4, 2010

Related U.S. Application Data
(60) Provisional application No. 61/252,165, filed on Oct. 16, 2009.

(51) Int. Cl. H02J 7/00

(52) U.S. Cl. 320/103

(57) ABSTRACT

A notebook computer battery pack device charges an external electrical device and powers a notebook computer. The notebook computer battery pack device includes battery cells for converting chemical energy into direct current power, a first interface connector for transferring the direct current power to a notebook computer, a second interface connector for transferring the direct current power to the external electrical device, battery management circuitry for providing circuit protection, and charging circuitry for charging the external electrical device through the second interface connector.

### Cross Reference To Related Applications

This application claims the benefit of U.S. Provisional Application No. 61/252,165, filed on Oct. 16, 2009 and entitled “DESIGNED MULTI-FUNCTIONAL NB BATTERY PACK,” the contents of which are incorporated herein by reference.

### BACKGROUND OF THE INVENTION

1. Field of the Invention

The present invention relates to notebook battery devices, and more particularly to a multifunctional notebook battery device capable of recharging an electronic device.

2. Description of the Prior Art

Notebook computers are a type of portable personal computer (PC) that operate with or without a power connection to an alternating current (AC) power grid. Notebook computers are able to provide portability due to inclusion of an internal power supply, e.g. a rechargeable battery pack that converts stored chemical energy into electrical energy. This makes notebook computers preferable for use when traveling, as an AC power outlet may not be available in every location at which a user of the notebook computer desires to operate the notebook computer. The rechargeable battery may be recharged by plugging an AC adapter of the notebook computer into a power socket, and inserting a power jack of the AC adapter into the notebook computer. The notebook computer may also be operated through power provided by the AC adapter.

While the battery pack is immensely useful for powering the notebook computer for hours of use without needing to be recharged, many other types of portable consumer electronic devices, such as portable music players, can only be recharged by an external 5 Volt supply through a Universal Serial Bus (USB) interface. A number of portable battery packs have been produced for recharging portable devices. However, such portable battery devices are typically heavy, and require carrying both the portable battery device itself and an extra AC adapter, in addition to the portable consumer electronic device. Utilizing a USB port of the notebook computer directly may be an option for recharging the portable consumer electronic device as well. However, internal circuitry of the notebook computer must be turned on for the USB port of the notebook computer to function, thereby wasting a significant amount of power, and potentially depleting all power of the rechargeable battery pack without fully recharging the portable consumer electronic device.

### SUMMARY OF THE INVENTION

According to an embodiment of the present invention, a notebook computer battery pack device is utilized for charging an external electrical device. The notebook computer battery pack device comprises a plurality of battery cells, a first interface connector, a second interface connector, battery management circuitry, and charging circuitry. The plurality of battery cells convert chemical energy into direct current power at a first voltage level. The first interface connector is electrically connected to a positive terminal of the plurality of battery cells and a negative terminal of the plurality of battery cells for transferring the direct current power to a notebook computer. The second interface connector is for transferring the direct current power to the external electrical device. The battery management circuitry is electrically connected to the plurality of battery cells and the first interface connector for providing circuit protection. The charging circuitry is electrically connected to the plurality of battery cells, the battery management circuitry and the second interface connector for charging the external electrical device through the second interface connector.

According to the above embodiment, a method of operating a notebook computer battery pack device is provided. The notebook computer battery pack device has a plurality of battery cells for providing DC power at a first voltage, and a first interface connector for connecting to a notebook computer. In the method, battery management circuitry of the notebook computer battery pack device detects connection of an external device to a second interface connector of the notebook computer battery pack device. The battery management circuitry enables charging circuitry of the notebook computer battery pack device upon detection of the external device being connected to the second interface connector. The charging circuitry charges the external device when the charging circuitry is enabled and the external device is connected to the second interface connector. The battery management circuitry performs circuit protection for the external device charged by the plurality of battery cells of the notebook computer battery pack device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a notebook battery pack device according to an embodiment of the present invention.

FIG. 2 is a flowchart diagram of an operation process of the notebook battery pack device of FIG. 1.

### DETAILED DESCRIPTION

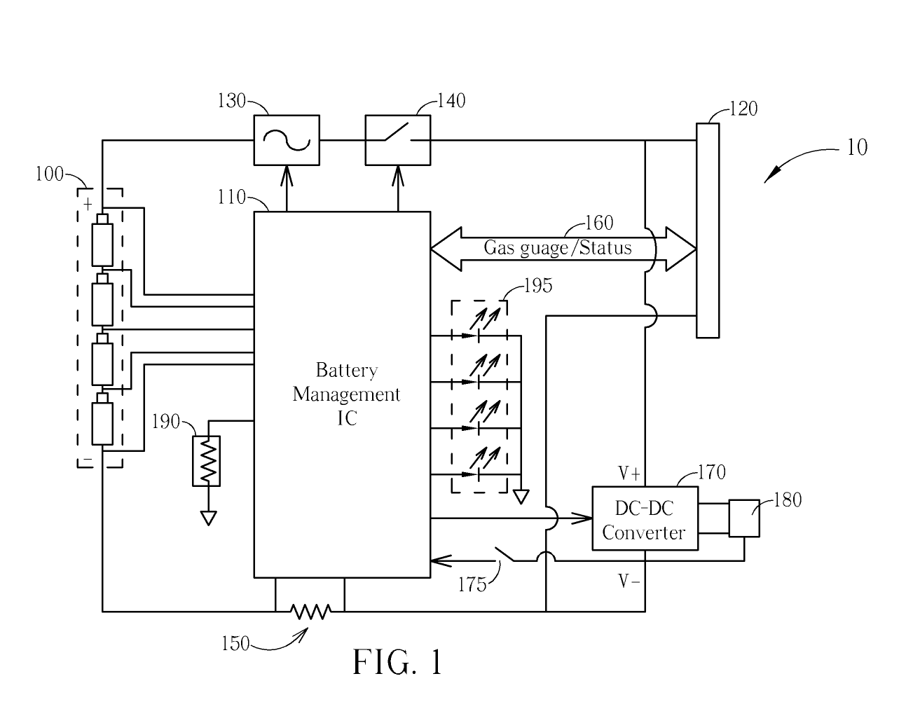

Please refer to FIG. 1, which is a block diagram of a notebook battery pack device 10 according to an embodiment of the present invention. The notebook battery pack device 10 may be installed in a housing, and may be electrically connected to a notebook computer for powering internal circuits and electrical devices, such as a hard disk drive and a liquid crystal display (LCD), of the notebook computer. The notebook battery pack device 10 may comprise a plurality of battery cells 100, a battery management integrated circuit (IC) 110, and a notebook charger connector 120 installed in the housing. The notebook charger connector 120 may be electrically connected to a positive terminal (+) and a negative terminal (−) of the plurality of battery cells 100. The notebook charger connector 120 may be electrically connected to the positive terminal of the plurality of battery cells 100 through a fuse 130 and a switch 140, and may be electrically connected to the negative terminal of the plurality of battery cells 100 through a current sensing resistor 150. Gas gauge and status messages may be transferred between the battery management IC 110 and the notebook charger connector 120 through a System Management Bus (SMBus) 160. The plurality of battery cells 100 may provide direct current (DC) power to the notebook computer at a voltage level ranging from 16 Volts to 18 Volts, though higher or lower voltages may also provided by the plurality of battery cells 100 for powering the notebook computer. The plurality of battery cells 100 may be arranged in any combination of series and parallel connections. For example, as shown in FIG. 1, the plurality of battery cells 100 may comprise four individual battery cells arranged in series. The battery management IC 110 may control the fuse 130 and the switch 140 for preventing overcurrent and/or overvoltage events from damaging the notebook computer. The switch 140 may be a transistor having a control terminal electrically connected to the battery management IC 110. The battery management IC 110 may also be electrically connected to first and second terminals of the current sensing resistor 150 for detecting the overcurrent event. The battery management IC 110 may have a terminal electrically connected to a thermister 190 for regulating output of the DC power in response to temperature variations detected through the thermister 190. The battery management IC 110 may also control a plurality of light-emitting diodes (LEDs) 195 for providing battery status messages to a user of the notebook computer. The plurality of LEDs 195 may be visible through the housing.

To provide a charging function for recharging battery packs of other portable consumer electronic devices, such as portable music players, the notebook battery pack device 10 further comprises a DC/DC (direct current to direct current) converter 170 for converting the DC power provided by the plurality of battery cells 100 at the voltage level to a second voltage level, such as from 16-18 Volts down to 5 Volts, compatible with a port interface connector 180 of a standard or proprietary interface, such as a Universal Serial Bus (USB) interface. The DC/DC converter 170 may comprise a first power terminal electrically connected to a terminal of the switch 140 and a pin of the notebook charger connector 120, and a second power terminal electrically connected to the first terminal of the current sensing resistor 150. The DC/DC converter 170 may further comprise an enable terminal electrically connected to the battery management IC 110 for receiving an enable/disable signal from the battery management IC 110 for enabling or disabling DC/DC conversion functions of the DC/DC converter 170. The DC/DC converter 170 may further comprise power and ground terminals electrically connected to power and ground pins of the port interface connector 180 for supplying the DC power at the second voltage level to a connected portable consumer electronic device. The battery management IC 110 may further be electrically connected to the port interface connector 180 for receiving a detection signal indicating whether or not a portable consumer electronic device is connected to the port interface connector 180. If the portable consumer electronic device is connected to the port interface connector 180, the battery management IC 110 may enable the DC/DC converter 170 for providing the DC power at the second voltage level to the portable consumer electronic device for recharging the portable consumer electronic device. If no device is connected to the port interface connector 180, e.g. if the portable consumer electronic device is disconnected from the port interface connector 180, the battery management IC 110 may disable the DC/DC converter 170. A second switch 175 may be electrically connected between the battery management IC 110 and the port interface connector 180. The second switch 175 may be a manually operated switch for keeping the DC/DC converter 170 turned off by the battery management IC 110 regardless of whether or not a device is connected to the port interface connector 180. The second switch 175 may be opened for disallowing reception of the detection signal from the port interface connector 180 by the battery management IC 110, so that the battery management IC 110 may disable the DC/DC converter 170. The second switch 175 may be closed for allowing reception of the detection signal from the port interface connector 180 by the battery management IC 110, so that the battery management IC 110 may selectively disable or enable the DC/DC converter 170 based on the detection signal received from the port interface connector 180. The second switch 175 may be a physical switch protruding through a housing of the notebook computer battery pack device. When the plurality of battery cells 100 are charging the portable consumer electronic device, the notebook computer need not be turned on, or even connected to the notebook charger connector 120, and the battery management IC 110 may provide overcurrent and/or overvoltage protection for protecting the portable consumer electronic device being charged from any overcurrent and/or overvoltage events.

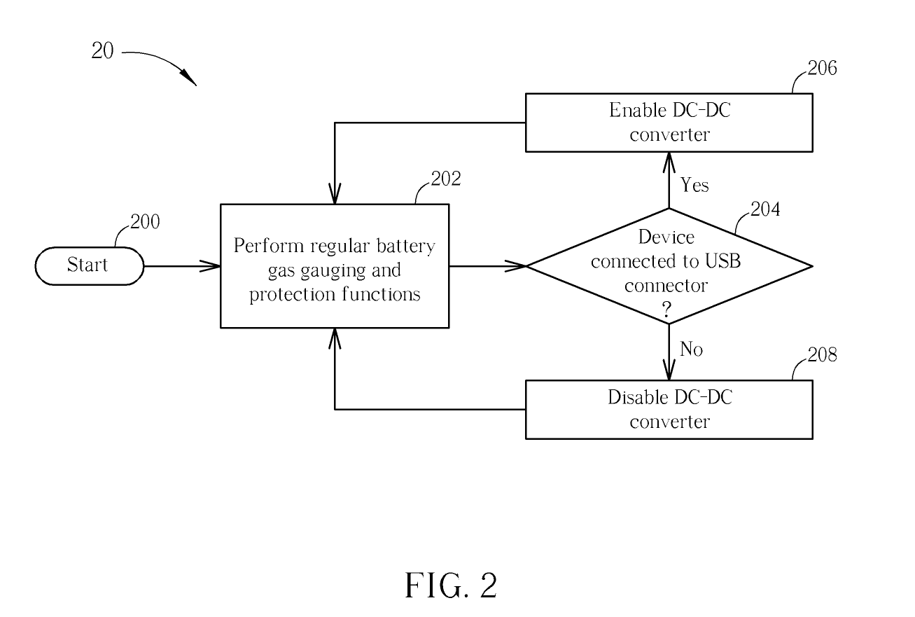

Please refer to FIG. 2, which is a flowchart diagram of an operation process 20 of the notebook battery pack device 10 of FIG. 1. The operation process 20 may be performed by the battery management IC 110 of the notebook battery pack device 10, and may comprise the following steps:

Step 200: Start;

Step 202: Perform gas gauge and protection functions for monitoring stored power and regulating DC power outputted by the notebook battery pack device;

Step 204: Is an external device connected to a port interface connector of the notebook battery pack device? If yes, proceed to Step 206; if no, proceed to Step 208;

Step 206: Enable a DC/DC converter for providing the DC power to the external device, and return to Step 202; and

Step 208: Disable the DC/DC converter, and return to Step 202.

In Step 202, as described above in the description of FIG. 1, the battery management IC 110 may provide gas gauge and protection functions for the plurality of battery cells 100. The gas gauge function may indicate a percentage of stored power remaining in the plurality of battery cells 100, and may also indicate time remaining before total depletion of the plurality of battery cells 100 according to electric current consumption of the external device and/or the notebook computer. The protection functions may include overcurrent protection and/or overvoltage protection. In Step 204, the external device may be a portable multimedia player, a cellular phone, a personal navigation device, a personal data assistant, or any other portable device comprising a rechargeable battery pack. If any such device is connected to the port interface connector 180 of the notebook battery pack device 10, Step 206 is performed to enable the DC/DC converter 170 for providing the DC power to the device for charging the rechargeable battery pack thereof. If no such device is connected to the port interface connector 180, the DC/DC converter 170 is disabled (Step 208), keeping the power and ground pins of the port interface connector 180 floating, and saving power by not operating the DC/DC converter 170. Please note that the battery management IC 110 may allow simultaneous power output through the notebook charger connector 120 and the port interface connector 180. However, in another embodiment, the battery management IC 110 may disable power output to either the notebook charger connector 120 or the port interface connector 180 if one or the other is in use. For example, if the external device is connected to the port interface connector 180, and the user attempts to utilize the notebook battery pack device 10 to power the notebook computer, the battery management IC 110 may disable powering of the notebook computer by the plurality of battery cells 100 unless the user disconnects the external device from the port interface connector 180. In another example, if the notebook computer is being powered by the plurality of battery cells 100 as managed by the battery management IC 110, the DC/DC converter 170 may be disabled by the battery management IC 110 until the notebook computer stops drawing power from the notebook battery pack device 10.

In the above, please note that the notebook battery pack device 10 may be removable from a housing of the notebook computer, or may be an internal component of the notebook computer. The port interface connector 180 may be a Universal Serial Bus (USB) connector, or the port interface connector 180 may be a connector of a different interface, such as IEEE 1394 (FireWire), or a proprietary connector.

The above embodiments of the notebook battery pack device provide plug and play operation, an international standard port interface, and high-speed power source transmission. Thus, the notebook battery pack device is able to provide recharging of portable consumer electronic devices through a simple USB cable even while the notebook computer is turned off. Use of the optional manual switch allows for selective enabling or disabling of the recharging function of the notebook battery pack device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A notebook computer battery pack device for charging an external electrical device, the notebook computer battery pack device comprising:
a plurality of battery cells for converting chemical energy into direct current power at a first voltage level;
a first interface connector electrically connected to a positive terminal of the plurality of battery cells and a negative terminal of the plurality of battery cells for transferring the direct current power to a notebook computer;
a second interface connector for transferring the direct current power to the external electrical device;
battery management circuitry electrically connected to the plurality of battery cells and the first interface connector for providing circuit protection; and
charging circuitry electrically connected to the plurality of battery cells, the battery management circuitry and the second interface connector for charging the external electrical device through the second interface connector.

2. The notebook computer battery pack device of claim 1, wherein the charging circuitry comprises:
a direct current to direct current (DC/DC) converter having:
a first power terminal electrically connected to a positive terminal of the plurality of battery cells;
a second power terminal electrically connected to a negative terminal of the plurality of battery cells;
an enable terminal electrically connected to the battery management circuitry; and
an output terminal electrically connected to a power pin of the second interface connector for outputting the DC power at a second voltage level different from the first voltage level.

3. The notebook computer battery pack device of claim 2, wherein the battery management circuitry is electrically connected to the second interface connector for receiving a detection signal according to connection of the external electrical device to the second interface connector, and the battery management circuitry is configured to disable the charging circuitry when no external electrical device is connected to the second interface connector.

4. The notebook computer battery pack device of claim 3, further comprising:
a switch having a first terminal electrically connected to the second interface connector, and a second terminal electrically connected to the battery management circuitry;
wherein the battery management circuitry is configured to disable the charging circuitry when the switch is open.

5. The notebook computer battery pack device of claim 4, wherein the switch is a physical switch protruding through a housing of the notebook computer battery pack device.

6. The notebook computer battery pack device of claim 2, wherein the battery management circuitry is configured to enable the DC/DC converter while the first interface connector is transferring the DC power to the notebook computer.

7. The notebook computer battery pack device of claim 2, wherein the second interface connector is a Universal Serial Bus connector.

8. The notebook computer battery pack device of claim 7, wherein the second voltage level is within a range utilized by Universal Serial Bus between a power pin and a ground pin of the Universal Serial Bus connector.

9. The notebook computer battery pack device of claim 1, wherein the battery management circuitry further provides gas gauging.

10. The notebook computer battery pack device of claim 1, further comprising:
a current sensing resistor having a first terminal electrically connected to the negative terminal of the plurality of battery cells, and a second terminal electrically connected to the first interface connector and the charging circuitry; and
a thermister having a first terminal electrically connected to the battery management circuitry and a second terminal electrically connected to ground.

11. A method of operating a notebook computer battery pack device having a plurality of battery cells for providing DC power at a first voltage, and a first interface connector for connecting to a notebook computer, the method comprising:
battery management circuitry of the notebook computer battery pack device detecting connection of an external device to a second interface connector of the notebook computer battery pack device;
the battery management circuitry enabling charging circuitry of the notebook computer battery pack device upon detection of the external device being connected to the second interface connector;
the charging circuitry charging the external device when the charging circuitry is enabled and the external device is connected to the second interface connector; and
the battery management circuitry performing circuit protection for the external device charged by the plurality of battery cells of the notebook computer battery pack device.

12. The method of claim 11, further comprising:
the battery management circuitry performing gas gauging for the notebook computer when the notebook computer is connected to the first interface connector.

13. The method of claim 11, further comprising:
the battery management circuitry disabling the charging circuitry when a switch electrically connected between the second interface connector and the battery management circuitry is open.

14. The method of claim 11, further comprising:
the battery management circuitry disabling the charging circuitry when no external device is connected to the second interface connector.

15. The method of claim 11, further comprising:
the charging circuitry converting the DC power from the first voltage level to a second voltage level;
wherein charging the external device when the charging circuitry is enabled and the external device is connected to the second interface connector comprises transferring the DC power at the second voltage level to the external device when the charging circuitry is enabled and the external device is connected to the second interface connector.
